(19) United States
(12) Patent Application Publication
(10) Pub. No.: US 2009/0071698 A1
(43) Pub. Date: Mar. 19, 2009

(54) CIRCUIT BOARD

(75) Inventors: CHIH-HANG CHAO, Tu-Cheng (TW); YU-HSU LIN, San Jose, CA (US); JENG-DA WU, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/863,276

(22) Filed: Sep. 28, 2007

(30) Foreign Application Priority Data
Sep. 13, 2007 (CN) 200720201018.3

(51) Int. Cl. H01R 12/04

(52) U.S. Cl. 174/257

(57) ABSTRACT

A circuit board includes a capacitor having two pins disposed thereon. A line determined by the two pins of the capacitor is not perpendicular to any of main sides of the circuit board.

### BACKGROUND

1. Field of the Invention

The present invention relates to circuit boards, particularly to a circuit board configured to prevent or minimize damage to a capacitor disposed on the circuit board when the circuit board suffers an impact.

2. Description of Related Art

a circuit board used in an electronic device normally includes a plurality of capacitors mounted thereon. The capacitors play an important role in ensuring constant current and voltage to be provided to the circuit board. Each capacitor has two pins mounted on the circuit board. The capacitor electrically communicates with other components of the circuit board via the two pins. In use, the circuit board may suffer impacts. When the pressure caused by an impact applied on the pins of the capacitor is too great, the pins will break, and the capacitor cannot work normally, thereby damaging the quality of the circuit board in the electronic device.

When impact is applied to the conventional circuit board, aforesaid things usually happen. Referring to FIG. 1, a conventional rectangular circuit board 10 is shown, which includes a capacitor 20 disposed thereon. The circuit board 10 defines two holes 11. The capacitor 20 includes two pins 21 inserted in the holes 11 and welded on the circuit board 10. An extension direction of a first side of the circuit board 10 is determined as X-axis direction. An extension direction of a second side adjacent and perpendicular to the first side is determined as Y-axis direction. A direction perpendicular to the X-axis direction and the Y-axis direction is determined as Z-axis direction. Usually, the main force of the impacts the circuit board 10 suffers during shipment is directed along the X-axis, Y-axis, and Z-axis directions. As shown in FIG. 2, a line determined by two pins 21 of the capacitor 20 is perpendicular to the X-axis. A software LS-DYNA is used for simulating stress distribution on the pins 21 of the capacitor 20 in FIG. 2 when the circuit board 10 suffers an impact. Simulation conditions are set as follows: the initial velocity of the circuit board 10 is 4.86 meters/second when the circuit board 10 suffers an impact, and a maximal acceleration of the circuit board 10 is determined to be 45 gravities. The stresses on the pins 21 of the capacitor 20 in the FIG. 2 during an impact are detailed in a table below:

| Orientation of line | | | |
|---|---|---|---|
| determined by pins of | Stress in megapascals (MPa) applied on the pins | | |
| the capacitor | X-axis impact | Y-axis impact | Z-axis impact |
| Pins aligned along Y- | 111.1 | 239.5 | 56.31 |
| axis | | | |

As can be seen in the above table, the pins 21 of the capacitor 20 on the conventional circuit board 10 of FIG. 2 suffer the most stress when an impact along the Y-axis is applied to the circuit board 10. That is, when the line determined by the pins of the capacitor is parallel to the impact direction, the stress applied to the pins may exceed the maximum stress value the pins can undergo. Therefore, the pins of the capacitor are easily damaged.

What is needed, therefore, is a new circuit board structure which provides protection to a capacitor therein when the circuit board suffers an impact.

### SUMMARY

A circuit board includes a capacitor having two pins disposed on the circuit board. A line determined by the two pins of the capacitor is not perpendicular to any of the edges of the circuit board.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is an isometric, perspective exploded view of a conventional circuit board;

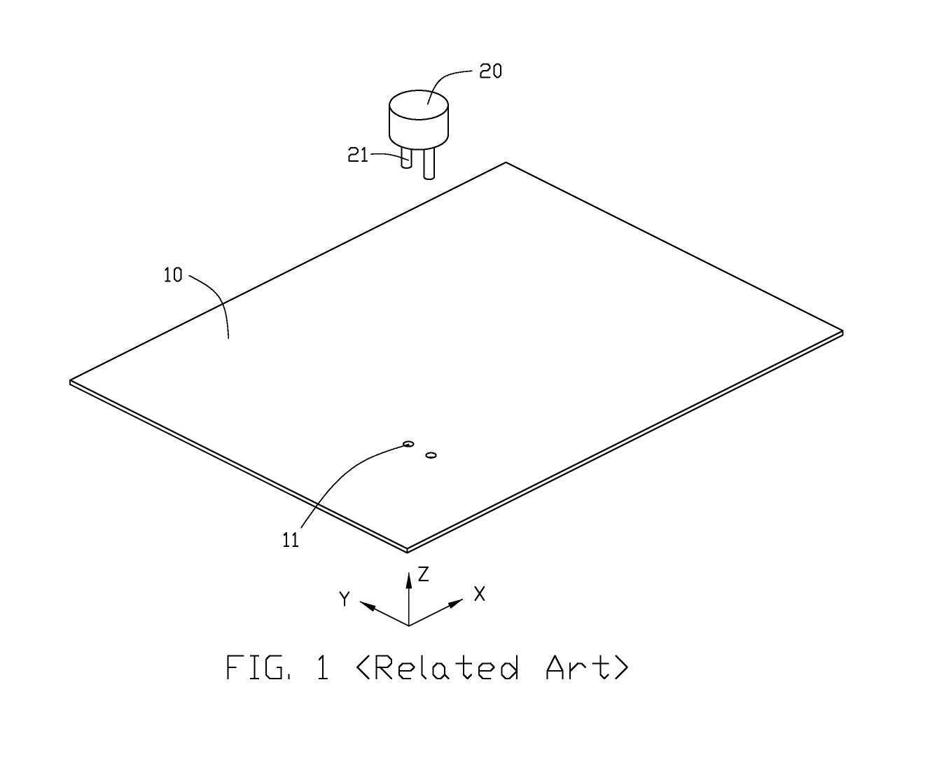

FIG. 2 is a plan view of the conventional circuit board;

FIG. 3 is an isometric, perspective exploded view of a circuit board in accordance with a first embodiment of the present invention;

FIG. 4 is a plan view of the present circuit board in accordance with the first embodiment;

FIG. 5 is a plan view of the present circuit board in accordance with a second embodiment;

FIG. 6 is a plan view of the present circuit board in accordance with a third embodiment;

FIG. 7 is a plan view of the present circuit board in accordance with a fourth embodiment; and

FIG. 8 is a plan view of the present circuit board in accordance with a fifth embodiment;

### DETAILED DESCRIPTION OF THE EMBODIMENTS

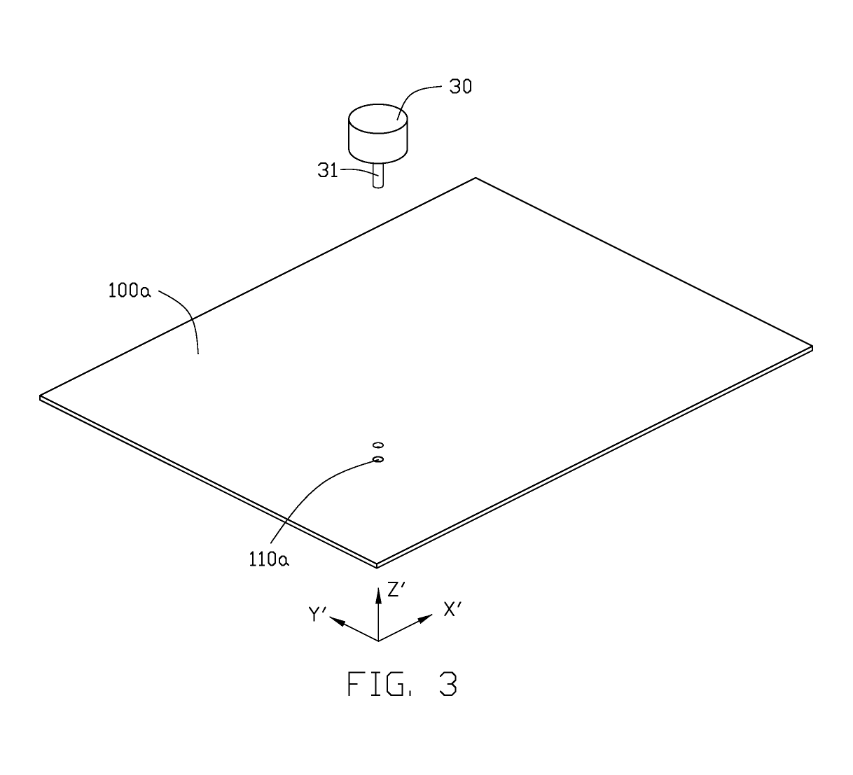

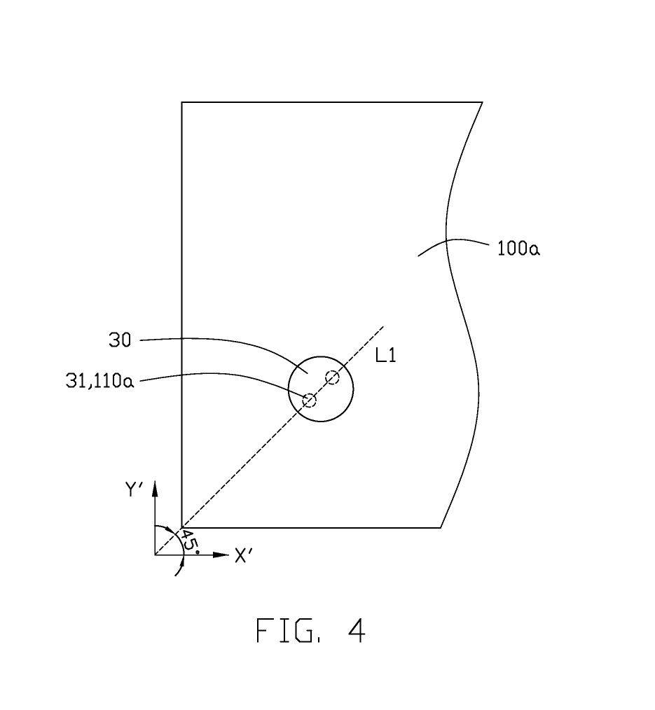

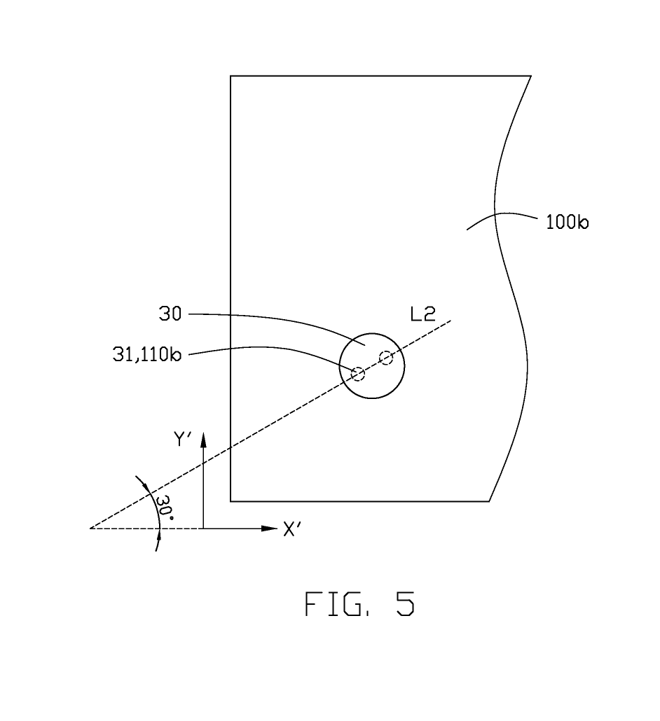

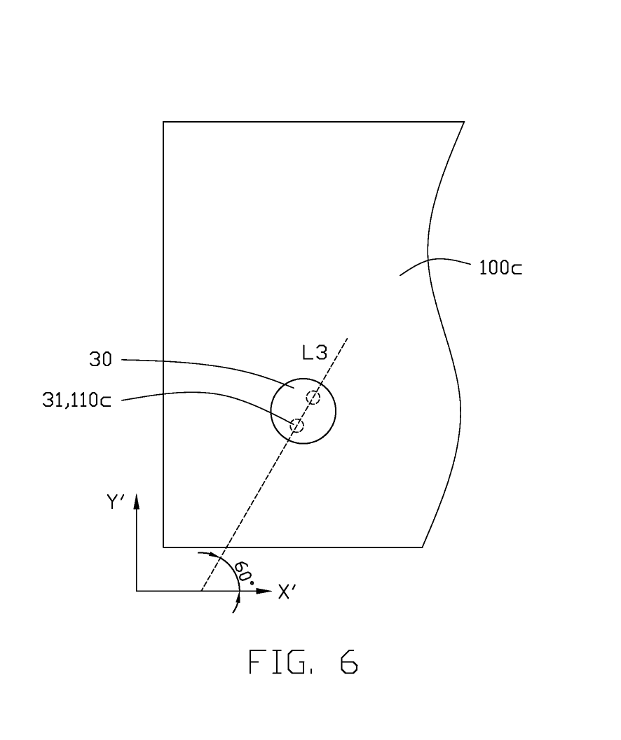

Referring to FIG. 3, a rectangular circuit board 100a according to a first embodiment includes a capacitor 30 mounted thereon. The capacitor 30 includes two pins 31. The circuit board 100a defines two holes 110 corresponding to the two pins 31. The pins 31 are inserted in the holes 110 and welded on the circuit board 100a. Thereby the capacitor 30 is mounted on the circuit board 100a for being electrically connected with other components. An extension direction of a first side of the rectangular circuit board 100a is designated as X′-axis direction. An extension direction of a second side of the rectangular circuit board 100a is designated as Y′-axis direction. A direction perpendicular to the X′-axis and Y′-axis is designated as Z′-axis direction. Most impacts suffered by the circuit board 100a during shipping will result in force directed along the X′-axis, Y′-axis, and Z′-axis directions. Referring to FIG. 4, there is a 45 degree angle between the X′-axis and a line L1 determined by the two pins 31 of the capacitor 30 or determined by the two holes 110a in the circuit board 100a according to the first embodiment. And also, there is a 45 degree angle between the line L1 and the Y′-axis. Referring also to FIG. 5, there is a 30 degree angle between the X′-axis and a line L2 determined by two pins 31 of the capacitor 30 or determined by two holes 110b in the circuit board 100b according to a second embodiment. Relatively, there is a 60 degrees angle between the line L1 and the Y′-axis. Referring also to FIG. 6, there is a 60 degrees angle between the X′-axis and a line L3 determined by two pins 31 of the capacitor 31 or determined by two holes 110c in the circuit board 100c according to a third embodiment. Relatively, there is a 30 degrees angle between the line L1 and the Y′-axis. That is, the angle between the line determined by the pins of the capacitor and the holes in the circuit boards 100a, 100b, and 100c and any of the sides/edges of the circuit boards 100a, 100b, and 100c is 30, 45, or 60 degrees.

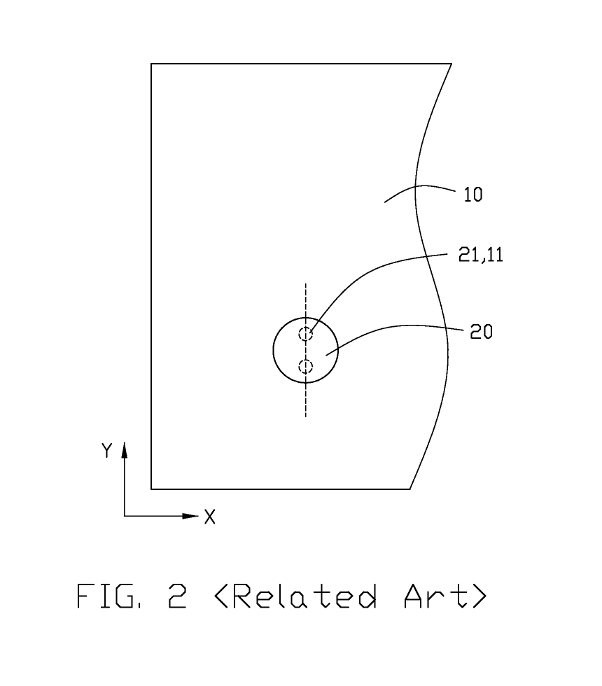

The software LS-DYNA is then used for simulating stress distribution on pins of the capacitor 30 of the circuit boards 100a, 100b, and 100c in FIGS. 4-6 when the circuit boards suffers an impact. Simulation conditions of the circuit boards 100a, 100b, and 100c are the same as that of the circuit board 10 of FIG. 2: e.g. the initial velocity of the circuit boards 100a, 100b, and 100c is 4.86 meters/second at impact, with a maximal acceleration determined to be 45 gravities. The stresses on the pins 31 during impact are detailed in a table below:

| Orientation of line | | | |
|---|---|---|---|
| determined by pins of | Stress in megapascals (MPa) applied on the pins | | |
| the capacitor | X′-axis impact | Y′-axis impact | Z′-axis impact |
| 45 degrees relative to | 106.5 | 106.1 | 58.55 |
| X′-axis | | | |
| 30 degrees relative to | 139.7 | 117.9 | 77.07 |
| X′-axis | | | |
| 60 degrees relative to | 119.6 | 141.5 | 82.6 |
| X′-axis | | | |

According to the above table, stress to the pins 31 of the capacitor 30 on the circuit boards 100a-c is more evenly distributed than in the conventional circuit board 10. When the angle between the line determined by the pins of the capacitor or holes in the circuit board and the X′-axis or Y′-axis is 45 degrees, the stresses applied to the pins 31 of the capacitor 30 caused by impacts along the X′-axis and Y′-axis directions are smaller than those of the conventional circuit board 10, especially the stress caused by the Y′-axis direction impact, which is 55.7% lower than that of the conventional circuit board 10. When the present circuit board suffers a Z′-axis direction impact, the stress value applied to the pins 31 of the capacitor 30 is small, which means no damage to the pins 31. If the angle between the line determined by the two pins 31 of the capacitor 30 and one of the X′-axis and Y′-axis directions is greater than the other one of the X′-axis and Y′-axis directions, the stress applied on the pins 31 caused by the impact in this direction is smaller. In other words, if the line determined by the two pins 31 of the capacitor 30 is angled closer to one of X′-axis and Y′-axis directions, the stress applied on the pins 31 caused by the impact in this direction is greater. And the greatest stress value applied to the pins 31 of the capacitor 30 of the present circuit boards 100a, 100b, and 100c is smaller than that of the conventional circuit board 10. Therefore, should the circuit boards 100a, 100b, and 100c suffer an impact, chances that the pins 31 of the capacitor 30 suffer damage are minimized or possibly eliminated with the present embodiments. The angle between the line determined by the two pins of the capacitor and one of the sides of the circuit board can be in the range from 25 degrees to 65 degrees. And, the effect of minimizing damage to the capacitor is better when the angle approaches to 45 degrees.

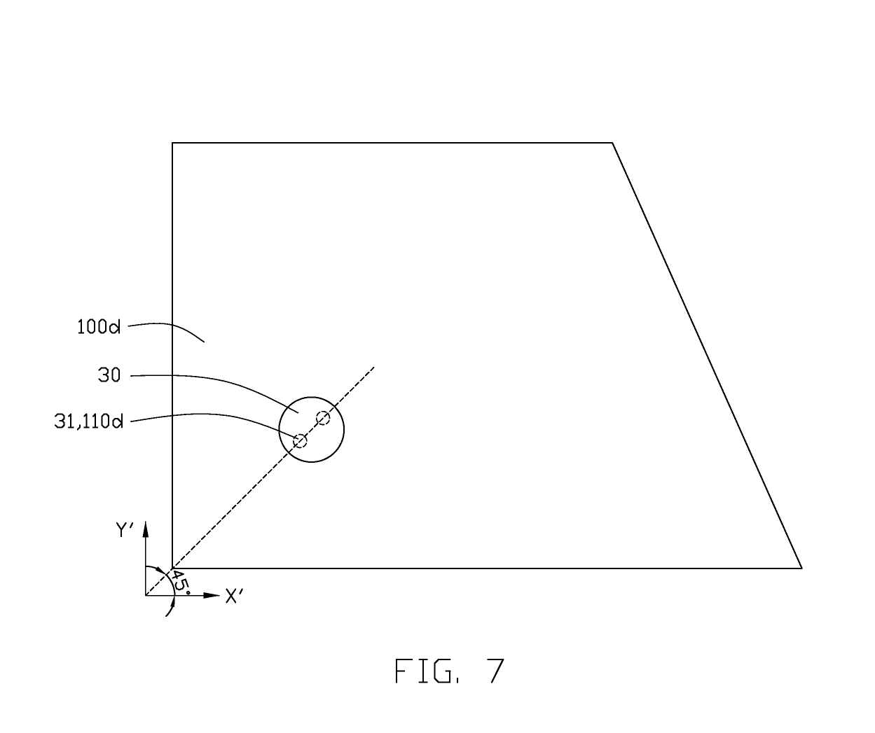

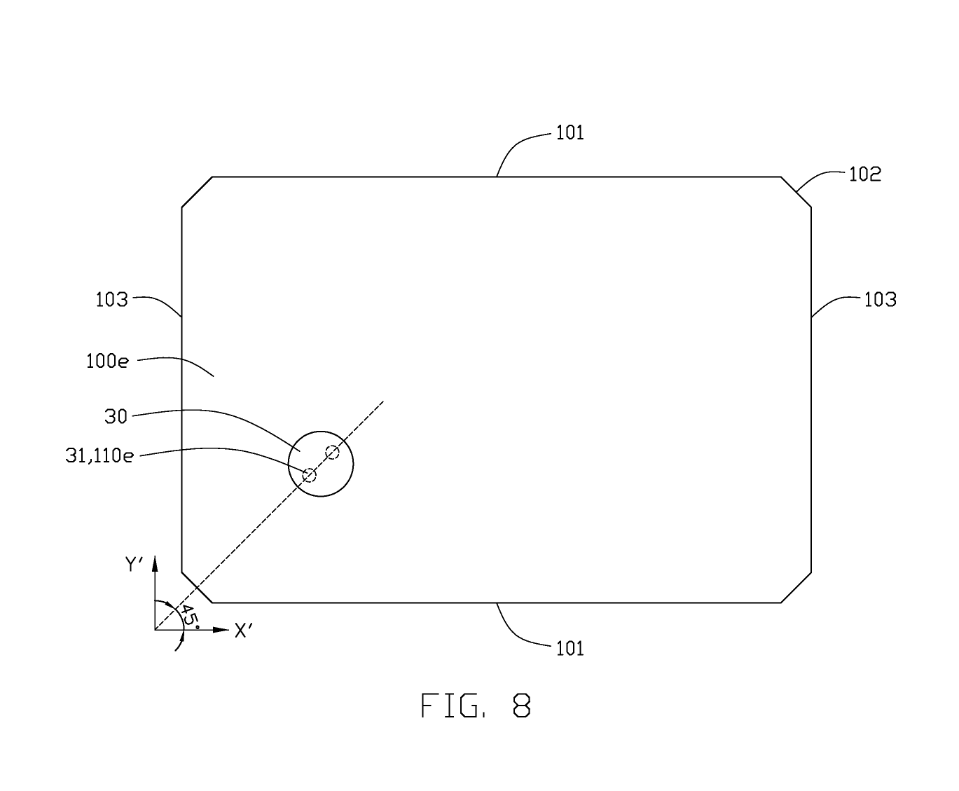

Referring also to FIGS. 7 and 8, the circuit board can also be other than rectangular. As shown in FIG. 7, the circuit board 100d is trapezoid-shaped with right angles. Stress is transmitted along directions perpendicular to the sides of the trapezoid shaped circuit board 100d. Therefore, the line determined by the two pins 31 of the capacitor 30 or two holes 110d in the circuit board 100d are not set perpendicular to the sides of the trapezoid-shaped circuit board. As shown in FIG. 8, the circuit board 100e includes two first main sides 101 parallel to each other and two second main sides 103 perpendicular the first main sides 101. Each first main side 101 and each second main side 103 is connected by a declined secondary side 102. Stress is transmitted along directions perpendicular to the main sides of the circuit board 100e. Therefore, the line determined by the two pins 31 of the capacitor 30 or two holes 110e in the circuit board 100e is not perpendicular to any of the main sides 101, 103 of the circuit board.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A circuit board having a plurality of main sides, comprising:
a capacitor having two pins disposed on the circuit board, a line determined by the two pins of the capacitor not perpendicular to any of the main sides of the circuit board.

2. The circuit board as described in claim 1, wherein two of the main sides of the circuit board are parallel to each other, and at least one main side of the circuit board is perpendicular to the two parallel main sides.

3. The circuit board as described in claim 2, wherein the circuit board is rectangular, and the line determined by the two pins of the capacitor is inclined substantially 45 degrees relative to one of the main sides of the circuit board.

4. The circuit board as described in claim 2, wherein the circuit board is rectangular, and the line determined by the two pins of the capacitor is inclined substantially 30 degrees relative to one of the main sides of the circuit board.

5. The circuit board as described in claim 2, wherein the circuit board defines two holes corresponding to the two pins of the capacitor, and the two pins are inserted in the two holes and welded to the circuit board.

6. The circuit board as described in claim 5, wherein the line determined by the two holes is inclined substantially 30 degrees relative to one of the main sides of the circuit board.

7. A circuit board having a plurality of main sides comprising:
two holes defined in the circuit board configured for two pins of a capacitor inserted therein, a line determined by the two holes not perpendicular to all of the main sides of the circuit board;

8. The circuit board as described in claim 8, wherein two of the main sides of the circuit board are parallel to each other, and at least one main side of the circuit board is perpendicular to the two parallel main sides.

9. The circuit board as described in claim 9, wherein the line determined by the two holes is inclined 45 degrees relative to one of the main sides of the circuit board.

10. The circuit board as described in claim 9, wherein the line determined by the two holes is inclined 30 degrees relative to one of the main sides of the circuit board.

11. An apparatus comprising:
a circuit board having a first straight edge and a second straight edge substantially perpendicular to the first straight edge, the circuit board having two mounting holes defined therein, a straight line determined by the mounting holes being obliquely oriented relative to the first straight edge and the second straight edge; and
a capacitor mounted on the circuit board, the capacitor having two pins inserted in the respective mounting holes of the circuit board.

12. The apparatus as described in claim 12, wherein the straight line is inclined an angle relative to the first straight edge and the second straight edge, the angle being in the range from 25 degrees to 65 degrees.

13. The apparatus as described in claim 12, wherein the straight line is inclined 45 degrees relative to the first straight edge and the second straight edge.

14. The apparatus as described in claim 12, wherein the straight line is inclined 30 degrees relative to the first straight edge and the second straight edge.
